(19) United States
(12) Patent Application Publication
(10) Pub. No.: US 2021/0153304 A1
(43) Pub. Date: May 20, 2021

(54) FAR-INFRARED RAY RADIATION SHEET, FLOOR HEATING SYSTEM, AND DOME TYPE HEATING DEVICE

(71) Applicants: MOZU CO., LTD., Tokyo (JP); IWC CO., LTD., Osaka (JP)

(72) Inventor: Kiyoyuki HISHIDA, Osaka (JP)

(73) Assignees: MOZU CO., LTD., Tokyo (JP); IWC CO., LTD., Osaka (JP)

(21) Appl. No.: 16/636,634

(22) PCT Filed: Sep. 29, 2017
(86) PCT No.: PCT/JP2017/035435

§ 371 Date: Feb. 4, 2020

(30) Foreign Application Priority Data
Aug. 7, 2017 (JP) 2017-003632

(51) Int. Cl. H05B 3/14; H05B 3/20; F24D 13/02

(52) U.S. Cl. CPC H05B 3/14; F24D 13/02; H05B 3/20

(57) ABSTRACT

Provided is a far-infrared ray radiation sheet capable of realizing a heating device exhibiting reduced heat unevenness and a high heat diffusion property, that is highly effective as a heater and good for a human body. There is provided a far-infrared ray radiation sheet 1 formed in a planar shape, that radiates far-infrared rays, the far-infrared ray radiation sheet comprising heat generation type mixed paper 20 formed by mixing a basic material and carbon fiber; electrodes 21 provided to the heat generation type mixed paper 20; heat diffusion type mixed paper 10 formed by mixing the basic material, and the carbon fiber or graphite exhibiting high heat conductivity, that is laminated on the heat generation type mixed paper 20; and prepregs and PET films 23 are laminated on the heat generation type mixed paper 20 and the heat diffusion type mixed paper 10, wherein the far-infrared rays are radiated by applying current to the electrodes 21.

### TECHNICAL FIELD

The present invention relates to a far-infrared ray radiation sheet formed in a planar shape, that radiates far-infrared rays; and to a floor heating system and a dome type heating device using the same.

### BACKGROUND ART

“Conduction”, “convection”, and “radiation” are exemplified as heat transmission, but according to conventional techniques relating to heating, there have been many techniques of transmitting heat by either “conduction” of heat or “convection” thereof. For example, as to hot air fed from an air-conditioner and a gas fan heater as well as hot water inside pipes in a hot water type floor system, heat is transmitted by “convection”. Further, for example, also provided has been a technique of serving as floor heating by “conducting” heat obtained from hot water or a nichrome wire. In order to diffuse heat from a heat source, aluminum or copper exhibiting excellent heat conductivity, that is formed in a film shape is attached onto a back surface of a floor by using it as a heat diffusion tool, that is, employed has been a technique of being attached onto the outermost surface of a heater.

On the other hand, as to heating techniques in which “radiation” of heat is used, Sheet-like heat generating elements each in which carbon fiber is used have been conventionally proposed as a heater for heating or air-conditioning. Sheet-like heat generating elements each using carbon fiber have attracted much attention as a heat generating element that radiates far-infrared rays, and are put to practical use as a far-infrared ray radiation sheet. The far-infrared ray radiation sheet is prepared by mixing carbon fiber in chopping shape in pulp or the like; providing electrodes to a sheet prepared by paper-making, using copper foils, silver paste and so forth; and being packed or laminated by insulators such as glass epoxy, PET films and so forth. Such a far-infrared ray radiation sheet exhibiting conductivity is used as a heater material that efficiently radiates far-infrared rays planarly.

For example, a far-infrared ray radiation sheet that more efficiently radiates far-infrared rays in a specific wavelength region is disclosed in the patent document 1. According to the far-infrared ray radiation sheet, carbon fiber is used as no mere heat generating element, but as a far-infrared ray radiation material; electrodes are provided to black-colored carbon fiber mixed paper; and it is so constituted that organic compound layers are laminated on the carbon fiber mixed paper. In addition, the far-infrared rays mean infrared rays having a wavelength in the range between approximately 4 μm and approximately 100 μm.

### PRIOR ART DOCUMENT

### Patent Document

Patent Document 1: Japanese Patent No. 3181506; the specification

### SUMMARY OF THE INVENTION

### Problems to be Solved by the Invention

However, according to conventional far-infrared ray radiation sheets, temperature is controlled by using a thermostat provided with thermal fuse, a PTC system, a thermistor, or the like, but it is known that there appears temperature unevenness of 10 to 20% within the same sheet. Further, “stuffy heat” is generated when continuing a state where heat dissipation is shielded, at an arbitrary location; thereby resulting in a local temperature rise. Specifically, the far-infrared ray radiation sheet is placed on a floor in a human life space, and thus there is high possibility that “stuffy heat” is generated at the location where furniture or the like is put.

In order to solve such a problem, it is necessary to diffuse heat, but aluminum, copper or the like used in the technique of “conduction” reflects far-infrared rays, and thus it cannot be used on the outermost surface of a radiation surface as a heat diffusion tool. In the heating technique in which such a “radiation” of far-infrared rays is used, no technique of efficiently diffusing heat has been proposed, and thus an effective solution has been desired.

The present invention has been made in view of such a situation, and it is an object to provide a far-infrared ray radiation sheet capable of realizing a heating device exhibiting reduced heat unevenness and a high heat diffusion property, that is highly effective as a heater and good for a human body; and to provide a floor heating system and a dome type heating device using the same.

### Means to Solve the Problems

(1) In order to achieve the above-described object, the present invention has taken steps as follows. That is, it is a feature that the far-infrared ray radiation sheet according to the present invention is a far-infrared ray radiation sheet formed in a planar shape, that radiates far-infrared rays, the far-infrared ray radiation sheet comprising heat generation type mixed paper formed by mixing a basic material and carbon fiber; electrodes provided to the heat generation type mixed paper; a heat diffusion sheet laminated on the heat generation type mixed paper, that absorbs the far-infrared rays and has a heat diffusion function; and organic compound layers laminated on the heat generation type mixed paper and the heat diffusion sheet, wherein the far-infrared rays are radiated by applying current to the electrodes.

In this manner, since a heat diffusion sheet that absorbs the far-infrared rays and has a heat diffusion function is laminated onto the heat generation type mixed paper, it becomes possible to enhance heat conductivity; temperature unevenness is reduced; and it also becomes possible to suppress generation of “stuffy heat” caused by a local temperature rise produced in a state where heat dissipation is shielded. Further, such a heat diffusion sheet diffuses heat and also has a function of absorbing and radiating the far-infrared rays, and thus it becomes possible to be used without shielding the radiation of the far-infrared rays and to promote heat diffusion at the same time, and it also becomes possible to improve the temperature unevenness, to suppress the local temperature rise, and to be laminated so as to closely adhere to an outermost surface layer portion on a radiation surface of the heat generation type mixed paper. The far-infrared ray radiation sheet according to the present invention exhibits high total emissivity of far-infrared rays in various temperature zones, and also has a highly stable emissivity in a wide wavelength band, thereby being highly effective as a heater.

(2) Further, it is a feature that the far-infrared ray radiation sheet according to the present invention is the far-infrared ray radiation sheet, wherein the heat generation type mixed paper and the heat diffusion sheet each are held and packed by a plurality of the organic compound layers to insulate the heat generation type mixed paper and the heat diffusion sheet from each other.

In this manner, the heat generation type mixed paper and the heat diffusion sheet each are held and packed by a plurality of the organic compound layers to insulate the heat generation type mixed paper and the heat diffusion sheet from each other, and thus it becomes possible to enhance heat conductivity and to increase an insulating property.

(3) Further, it is a feature that the floor heating system according to the present invention is a floor heating system using far-infrared rays, the floor heating system comprising heat generation type mixed paper formed by mixing a basic material and carbon fiber; electrodes provided to the heat generation type mixed paper; a heat diffusion sheet laminated on the heat generation type mixed paper, that absorbs the far-infrared rays and has a heat diffusion function; organic compound layers laminated on the heat generation type mixed paper and the heat diffusion sheet; a thermostat that switches current application or non-current application to the heat generation type mixed paper by detecting temperature; a sensor that detects the temperature; and a control section that controls the current application for the heat generation type mixed paper in accordance with the temperature detected by the sensor, wherein the control section applies current to the electrodes to radiate the far-infrared rays.

In this manner, a heat diffusion sheet that absorbs the far-infrared rays and has a heat diffusion function is laminated onto the heat generation type mixed paper, and thus it becomes possible to enhance heat conductivity and to reduce temperature unevenness. Further, such a heat diffusion sheet diffuses heat and also has a function of absorbing and radiating the far-infrared rays, and thus it becomes possible to be used without shielding the radiation of the far-infrared rays and to promote heat diffusion at the same time, and it also becomes possible to improve the temperature unevenness, to suppress the local temperature rise, and to be further laminated so as to closely adhere to an outermost surface layer portion on a radiation surface of the heat generation type mixed paper. The far-infrared ray radiation sheet according to the present invention exhibits high total emissivity of far-infrared rays in various temperature zones, and also has a highly stable emissivity in a wide wavelength band, thereby being highly effective as a heater.

(4) Further, it is a feature that the dome type heating device according to the present invention is a dome type heating device that radiates far-infrared rays, the dome type heating device comprising a frame, both ends of which are opened, that is formed in a semi-cylindrical shape; the far-infrared ray radiation sheet according to the above-described (1) or (2), that is provided on an inner surface of the frame; and cover sections that cover the frame and the far-infrared ray radiation sheet.

According to this configuration, a heat diffusion sheet diffuses heat and also has a function of absorbing and radiating the far-infrared rays, and thus it becomes possible to be used without shielding the radiation of the far-infrared rays and to promote heat diffusion at the same time. Further, it becomes possible to be laminated so as to closely adhere to an outermost surface layer portion on a radiation surface of the heat generation type mixed paper. Further, the far-infrared ray radiation sheet according to the present invention exhibits high total emissivity of the far-infrared rays in various temperature zones, and further since emissivity in a wavelength band called growth rays most effectively acting on a human body is extremely high and stable, it becomes possible to realize a heating device that is good for a human body.

### Effect of the Invention

According to the present invention, it becomes possible to suppress a local temperature rise by accelerating heat diffusion at heat generation places. Further, a heat diffusion sheet diffuses heat and also has a function of absorbing and radiating far-infrared rays, and thus it becomes possible to be used without shielding radiation of the far-infrared rays and to promote heat diffusion at the same time, and it becomes possible to improve temperature unevenness and to be laminated so as to closely adhere to an outermost surface layer portion on a radiation surface of a heat generation type mixed paper. Further, not only high total emissivity of the far-infrared rays in various temperature zones but also highly stable emissivity in a wide wavelength band is obtained, thereby being highly effective as a heater. Further, growth rays stably exhibiting high emissivity can be radiated, and thus it becomes possible to realize a heating device that is good for a human body.

### BRIEF DESCRIPTION OF THE DRAWINGS

FIG. 1A is an exploded diagram of a far-infrared ray radiation sheet according to the present embodiment.

FIG. 1B is an exploded diagram of a far-infrared ray radiation sheet according to the modified example.

FIG. 2 is an “experimental kit structural diagram” showing an outline of a device according to the present verification.

FIG. 3 is an “experimental kit plan view” showing an outline of the device according to the present verification.

FIG. 4A is a “camera installation part structural diagram” for making a comparison in far-infrared radiation energy amount measurement between a conventional type far-infrared ray radiation sheet and a graphite sheet lamination type far-infrared ray radiation sheet according to the present embodiment.

FIG. 4B is an “experimental kit structural diagram” for making a comparison in far-infrared radiation energy amount measurement between a conventional type far-infrared ray radiation sheet and a graphite sheet lamination type far-infrared ray radiation sheet according to the present embodiment.

FIG. 4C is an “experimental kit plan view” for making a comparison in far-infrared radiation energy amount measurement between a conventional type far-infrared ray radiation sheet and a graphite sheet lamination type far-infrared ray radiation sheet according to the present embodiment.

FIG. 4D is an “experimental kit side view” for making a comparison in far-infrared radiation energy amount measurement between a conventional type far-infrared ray radiation sheet and a graphite sheet lamination type far-infrared ray radiation sheet according to the present embodiment.

FIG. 5A is a diagram showing a measurement result of a spectral emissivity spectrum at room temperature, of a conventional type “graphite-free sheet”.

FIG. 5B is a diagram showing a measurement result of a spectral emissivity spectrum at room temperature, of a “graphite lamination type sheet” according to the present embodiment.

FIG. 6A is a diagram showing a schematic configuration of a floor heating system according to the present embodiment.

FIG. 6B is a diagram showing a schematic configuration of a floor heating system according to the present embodiment.

FIG. 6C is a schematic diagram of the far-infrared ray radiation sheet 1 provided with a thermostat.

FIG. 7A is a diagram showing an outline of a tatami mat type floor heating system.

FIG. 7B is an exploded configuration diagram of a tatami mat type floor heating system.

FIG. 7C is an exploded side view of a tatami mat type floor heating system.

FIG. 7D is an exploded side view of a tatami mat type floor heating system.

FIG. 8A is an exploded diagram of a dome type heating device according to the present embodiment.

FIG. 8B is a cross-sectional view in the case of cutting a dome type heating device at the approximate center in an axial direction as a cylinder.

FIG. 8C is a plan view of a far-infrared ray radiation sheet used for a dome type heating device.

### DETAILED DESCRIPTION OF EMBODIMENTS

The present inventor has found out that temperature unevenness and “stuffy heat” can be suppressed by using mixed paper in which carbon fiber or graphite exhibiting high heat conductivity is mixed while paying attention to the fact that as characteristics of a far-infrared ray radiation sheet, there is the temperature unevenness, and “stuffy heat” is generated at an arbitrary location, when continuing a state where heat dissipation is shielded, resulting in local temperature rise; and the inventor has reached the present invention. Conventionally, a heat diffusion sheet using carbon fiber or graphite exhibiting high heat conductivity has been utilized as a heat dissipation sheet such as mainly a heat sink or the like, but according to the present invention, heat diffusion efficiency is improved by laminating a heat diffusion sheet on the radiation surface of a heat generation type mixed paper to be used as a heat diffusion tool.

That is, it is a feature that a far-infrared ray radiation sheet according to the present invention is a far-infrared ray radiation sheet formed in a planar shape, that radiates far-infrared rays, the far-infrared ray radiation sheet comprising heat generation type mixed paper formed by mixing a basic material and carbon fiber; electrodes provided to the heat generation type mixed paper; a heat diffusion sheet laminated on the heat generation type mixed paper, that absorbs the far-infrared rays and has a heat diffusion function; and organic compound layers laminated on the heat generation type mixed paper and the heat diffusion sheet, wherein the far-infrared rays are radiated by applying current to the electrodes.

Consequently, the present inventor has made it possible to enhance heat conductive efficiency of a far-infrared ray radiation sheet, and made it possible to improve temperature unevenness, to suppress local temperature rise, and to be laminated so as to closely adhere to the outermost surface layer portion on a radiation surface of a heat generation type mixed paper. Further, it has been made possible to realize a heating device that is good for a human body, while realizing high total emissivity of far-infrared rays in various temperature zones as well as a highly stable emissivity in a wide wavelength band. Next, embodiments according to the present invention will be specifically described referring to the drawings.

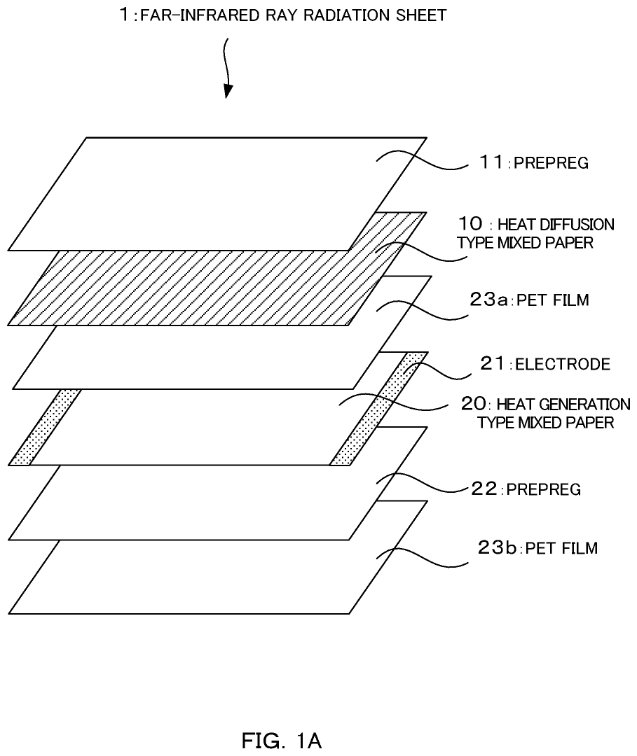

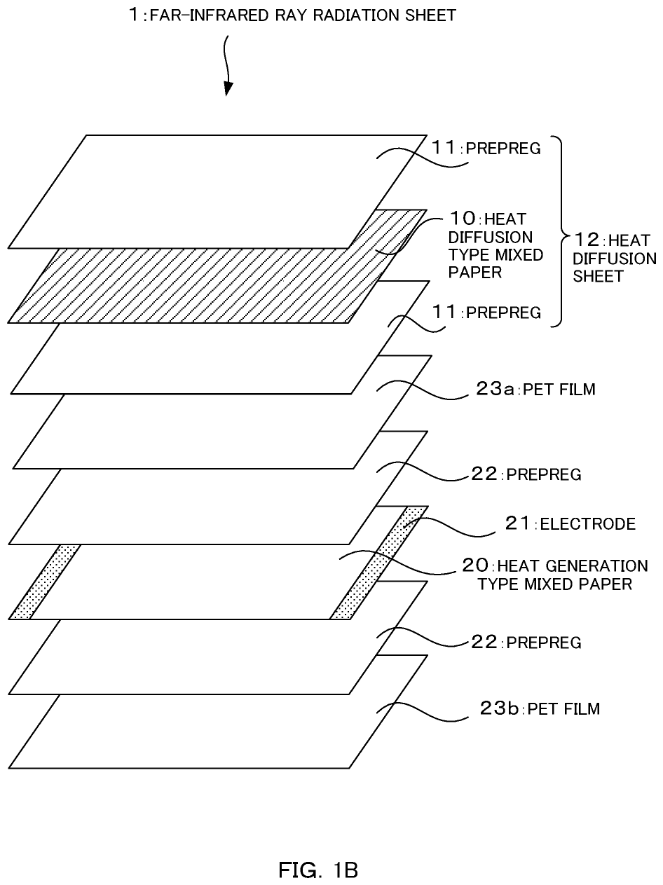

FIG. 1A is an exploded diagram of a far-infrared ray radiation sheet according to the present embodiment. As to this far-infrared ray radiation sheet 1, the heat diffusion type mixed paper 10 is held by the prepreg 11 having a thickness of 0.1-0.2 mm, and the PET (Polyethylene terephthalate) film 23a having a thickness of 0.1 mm. This prepreg means a plastic molding material obtained by evenly impregnating a fibrous reinforcing material such as a glass cloth, carbon fiber or the like with a thermosetting resin such as epoxy or the like obtained by mixing an additive such as a curing agent, an adhesion material or the like, followed by heating and drying. According to the present embodiment, the prepreg 11 having a thickness of 0.1-0.2 mm is used, but the present invention is not limited thereto, and it is possible to appropriately change the thickness. For example, a prepreg containing an epoxy resin slightly more than conventional glass epoxy is also usable in such a manner that thickness at the portion where the prepreg 11 comes into contact with the heat diffusion type mixed paper 10, and thickness at the portion where the prepreg 11 comes into contact with the PET film 23a become even.

Next, the heat diffusion mixed paper 10 as a heat diffusion sheet according to the present embodiment is prepared as heat diffusion mixed paper by compressively paper-making graphite to a basic material containing carbon fiber. In addition, the present invention is not limited thereto, and an existing graphite sheet as well as a graphite sheet can be used. That is, it is applicable when being a sheet that absorbs far-infrared rays and has a function of promoting heat diffusion. As shown in FIG. 1A, according to the present embodiment, this heat diffusion type mixed paper 10 is situated at the outermost surface layer portion with respect to a radiation surface of the after-mentioned heat generation type mixed paper 20.

A heat generation type mixed paper 20 is provided with electrodes 21 at both end portions of the paper surface in FIG. 1A, and is held by the above-described PET film 23a and a prepreg 22 having a thickness of 0.1-0.2 mm. Further, the heat generation type mixed paper 20 is accompanied with a PET film 23b having a thickness of 0.1 mm on the lower most surface for insulation and protection thereof.

In addition, according to the present embodiment, the prepreg 11 having a thickness of 0.1-0.2 mm is used, but the present invention is not limited thereto, and it is possible to appropriately change the thickness. For example, a prepreg containing an epoxy resin slightly more than conventional glass epoxy is also usable in such a manner that thickness at the portion where the prepreg 22 comes into contact with the heat diffusion type mixed paper 20, and thickness at the portion where the prepreg 22 comes into contact with the PET film 23a become even. Further, according to the present embodiment, the heat diffusion type mixed paper 10 is provided at the outermost surface layer with respect to a radiation surface of the heat generation type mixed paper 20, but the present invention is not limited thereto, and it is also possible to adopt modes in which the heat diffusion type mixed paper 10 is laminated on a vertically lower side with respect the heat generation type mixed paper 20, and the heat generation type mixed paper 20 is laminated so as to sandwich it from top and bottom.

As to the heat generation type mixed paper 20, for example, those disclosed in the specification according to Japanese Patent No. 3181506 are usable (the present invention is not limited thereto). That is, the heat generation type mixed paper 20 is prepared as described below. Pulp liquid is prepared by adding water in bast fiber such as paper mulberry, paper bush, diplomorpha sikokiana, or the like, and carbon fiber that has been cut into about 5 mm long is mixed therein and dispersed. The pulp liquid is made to flow on a paper-making net to form a wet sheet. The wet sheet is mechanically dehydrated and dried using squeezing rolls, and is subsequently cut to predetermined dimensions. In this manner, the heat generation type mixed paper 20 having a thickness of roughly 0.1 mm is formed.

Next, belt-shaped silver paste or copper paste is printed along two facing sides of the heat generation type mixed paper 20, and a copper foil is attached onto the silver paste or copper paste to form electrodes 21. Then, it is effective to coat a black substance such as a black paint or the like on the heat generation type mixed paper 20, or to impregnate the heat generation type mixed paper with the black substance such as the black paint or the like. As black substances, exemplified are for example, CuO (copper oxide), Fe₃O₄ (magnetite or ferric oxide), Fe₃P (iron phosphide), Fe₂MgO₄ (magnesium oxide iron), Fe (C₉H₇)₂ (bisindenyl iron) and so forth. In addition, the heat generation type mixed paper 20 may be colored black before attaching a pair of electrodes 21 to the heat generation type mixed paper 20. Further, according to the manufacturing process of the heat generation type mixed paper 20, a black heat generation type mixed paper 20 may be prepared by mixing and dispersing a black substance such as black pigment or the like in the pulp liquid. In addition, an insulating property between the heat diffusion type mixed paper 10 and the heat generation type mixed paper 20 is secured by a PET film 23a sandwiched therebetween.

In this manner, since the heat diffusion type mixed paper 10 is laminated onto the heat generation type mixed paper 20, it becomes possible to enhance heat conductivity; temperature unevenness is improved; and it becomes possible to suppress a local temperature rise. Further, such a heat diffusion type mixed paper 10 diffuses heat and also has a function of absorbing and radiating far-infrared rays, and thus it becomes possible to be used without shielding the radiation of the far-infrared rays and to promote heat diffusion at the same time, and it becomes possible to be laminated so as to closely adhere to an outermost surface layer portion on a radiation surface of the heat generation type mixed paper 20.

### Modified Example

FIG. 1B is an exploded diagram of a far-infrared ray radiation sheet according to the modified example. As to this far-infrared ray radiation sheet 1, the heat diffusion type mixed paper 10 is packed by a set of prepregs 11 each having a thickness of 0.1-0.2 mm, and is subjected to glass epoxy plate formation, thereby constituting a heat diffusion sheet 12.

The heat generation type mixed paper 20 provided with electrodes 21 at both end portions of the paper surface in FIG. 1B is packed by a set of prepregs 22 each having a thickness of 0.1-0.2 mm, and is subjected to glass epoxy plate formation.

Further, the heat generation type mixed paper 20 having been subjected to the glass epoxy plate formation is packed by a set of PET films (Polyethylene terephthalate) 23a and 23 b each having a thickness of 0.1 mm, from the both surfaces for insulation and protection thereof.

From such a configuration, an insulating property between the heat diffusion type mixed paper 10 and the heat generation type mixed paper 20 is secured by a PET film 23a sandwiched therebetween. In addition, one as well as a plurality of heat diffusion sheets 12 may be provided. That is, it is also possible to adopt a mode in which at least one heat diffusion sheet 12 is laminated at any one of the uppermost position to the lowermost position, and a mode in which it is laminated at the uppermost position as well as the lowermost position.

[Verification with regard to influence on heat diffusion effect and two-dimensional heat distribution uniformization effect of graphite sheets]

Next, the verification with regard to influence on heat diffusion effect and two-dimensional heat distribution uniformization effect of graphite sheets will be explained. Herein, the verification has been made using a far-infrared ray radiation sheet shown in FIG. 1A.

### [Verification Period]

Jan. 24, 2017-Feb. 1, 2017

### [Verification Purpose]

It is proved by numerical values to improve heat diffusivity with means of laminating the heat diffusion type mixed paper using carbon fiber or graphite exhibiting high heat conductivity to the heat generation type mixed paper according to the present embodiment on the radiation surface of far-infrared rays; and to be useful for uniformizing a two-dimensional heat distribution. In addition, there are several kinds of options such as a graphite sheet and so forth as a sheet (heat diffusion type mixed paper) using carbon fiber or graphite exhibiting high heat conductivity, but of these, a graphite sheet obtained by compressively paper-making natural graphite (hereinafter, referred to as “graphite sheet”) is used in the present verification, also taking into consideration prices and availability. Further, the heat diffusivity is affected by heat capacity of a sheet, and thus two kinds of “thin” and “thick” graphite sheets have been verified.

### [Verification Place]

“Ensekiou technology center at the first IWC factory” inside IWC INC.

### [Verification Outline]

A flooring floor using a far-infrared ray radiation sheet in which no graphite sheet is laminated (hereinafter, referred to as “graphite-free sheet”), and a sheet in which a graphite sheet is laminated on the radiation surface of a far-infrared ray radiation sheet (hereinafter, referred to as “graphite lamination type sheet”) is reproduced, and contact type digital thermometers each (hereinafter, referred to as “thermometer”) are arranged. Heating is started, and temperatures at three points are measured in a temperature-stable state after reaching the setting temperature to compare a uniformizing state of heat distribution therewith. Then, abnormal heat generation is artificially generated using a heat insulating material provided with urethane-based aluminum, and it is confirmed that the graphite sheet is useful for heat dissipation by measuring temperature changes of an abnormal heat generation zone and a heat dissipation zone at each lapse of time.

### [Verification Conditions]

Room temperature: 15.6° C. to 16.3° C.

Setting temperature of a controller provided with a temperature control sensor (hereinafter, referred to as “controller”): 50° C.

Thin graphite lamination type sheet: a thickness of 65 μm, and a heat conductivity (in the planar direction) of 80 W/m·K

Thick graphite lamination type sheet: a thickness of 105 μm, and a heat conductivity (in the planar direction) of 120 W/m·K

### [Verification Device]

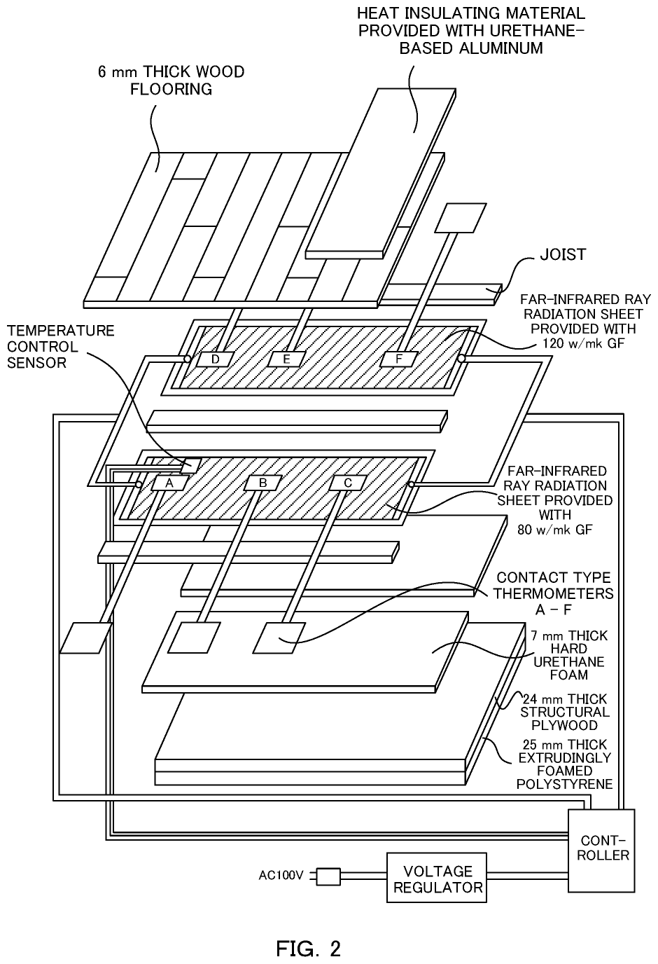

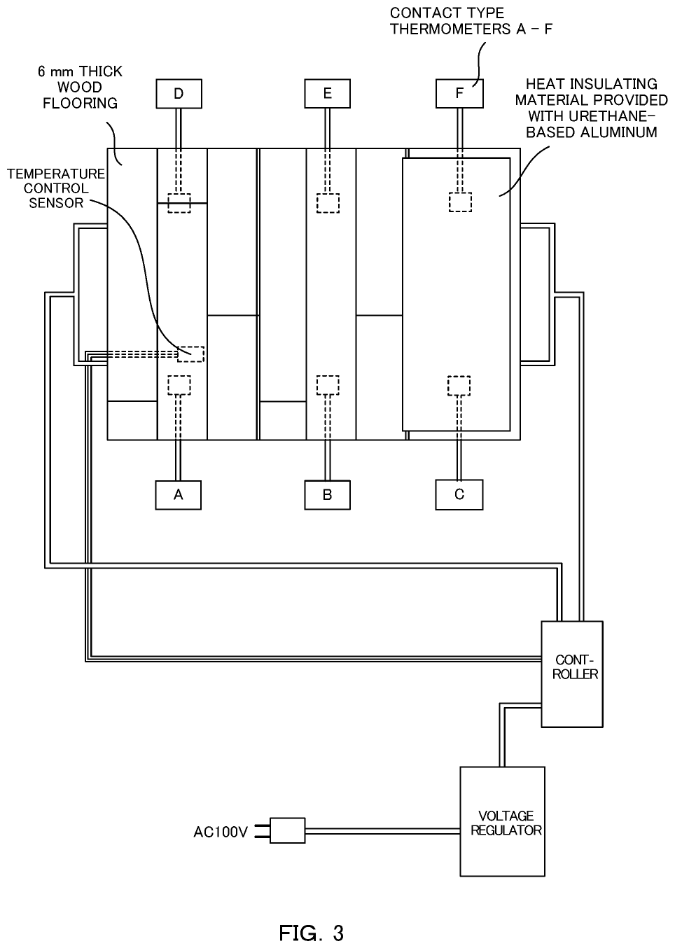

FIG. 2 is an “experimental kit structural diagram” showing an outline of a device according to the present verification, and FIG. 3 is an “experimental kit plan view” showing an outline of the device according to the present verification.

(1) Thermometers are arranged at A (place that is 20 cm away from a heat dissipation zone), B (heat dissipation zone), and C (abnormal heat generation zone), respectively on a thin graphite lamination type sheet (80 W).

(2) Thermometers are arranged at D (place that is 20 cm away from a heat dissipation zone), E (heat dissipation zone), and F (abnormal heat generation zone), respectively on a thick graphite lamination type sheet (120 W).

(3) Thermometers are arranged at A (place that is 20 cm away from a heat dissipation zone), B (heat dissipation zone), and C (abnormal heat generation zone), respectively, using a graphite-free sheet in place of the thin graphite lamination type sheet.

(4) A controller is arranged to set a control temperature during verification to 50° C.

### [Verification Procedures]

Those for the following sheets (a)-(c) each are carried out in the order of (Procedure 1) to (Procedure 6) as described below.

(a) Graphite-free sheet

(b) Thin graphite lamination type sheet

(c) Thick graphite lamination type sheet

(Procedure 1) Heating is started after setting the controller to 50° C.

(Procedure 2) After temperature of the controller reaches 50° C. (peak temperature), it is confirmed that rise temperature becomes stable by measuring a numerical value of a thermometer, and a heat unevenness index is found from the temperature at the time to compare uniformity of a two-dimensional heat distribution therewith.

(Procedure 3) After confirming that the temperature has become stable via the above-described (Procedure 2), abnormal heat generation is generated by arranging a heat insulating material provided with urethane-based aluminum on each of thermometers C and F.

(Procedure 4) Temperature changes are measured under the abnormal heat generation, and measured by setting when abnormal heat generation zone sheet surface temperature of the above-described (a) graphite-free sheet reaches 94° C., as an upper limit.

(Procedure 5) At each thermometer installation place, a numerical value difference between stable peak temperature under a normal heat generation state and a peak temperature at the above-described (Procedure 4) time from a start of the abnormal heat generation is found to verify the heat diffusion effect.

(Procedure 6) In order to clarify influence given to heat diffusivity by heat capacity, as to graphite lamination type sheets, the verification is continued until normal heat generation zone sheet surface temperature of any of the above-described (b) thin graphite lamination type sheet and (c) thick graphite lamination type sheet reaches 94° C. Herein, since the temperature limit of contact type digital thermometers is “95° C.”, it is because reaching this is prevented to set to “94° C.”.

[Result/Result with Regard to Two-Dimensional Heat Distribution Uniformization Effect]

Herein, as to each of the graphite-free sheet and thick/thin graphite lamination type sheets, the temperature difference is shown by comparing average temperature at three location points of A/D (each place that is 20 cm away from a heat dissipation zone), B/E (respective heat dissipation zones), and C/F (respective abnormal heat generation zones) with a highest temperature as well as a lowest temperature in measurement points A, B and C or measurement points D, E and F with respect to the foregoing.

(α) The temperature difference between the average temperature and the highest temperature as well as the lowest temperature is represented as “heat unevenness index)”.

(β) The “heat unevenness index” means one obtained by adding the temperature difference values of the highest temperature and the lowest temperature, respectively, with respective to the average temperature, irrespective of the plus direction as well as the minus direction.

(γ) It can be determined that the lower the heat unevenness index value, the smaller the heat unevenness is (that is, uniformization of a two-dimensional heat distribution is achieved).

TABLE 1
Heat unevenness index comparison when
the rise temperature is stable.

| | Three | | | |
|---|---|---|---|---|
| | location | | | Heat |
| | points | Highest | Lowest | unevenness |
| | average | temperature | temperature | index |
| Graphite-free | 56.56° C. | 60.2° C. | 54.6° C. | 5.60 |
| sheet | | | | |
| Graphite | 52.16° C. | 53.8° C. | 51.3° C. | 2.50 |
| lamination type | | | | |
| sheet/thin | | | | |
| Graphite | 52.23° C. | 54.0° C. | 50.9° C. | 3.10 |
| lamination type | | | | |
| sheet/thick | | | | |

In the above-described Table, when comparing heat unevenness indices, any of thin/thick graphite lamination type sheets has lower index than that of a graphite-free sheet, and thus it has been made clear that means of laminating a graphite sheet on a radiation surface has the effect of uniformizing a two-dimensional heat distribution.

[Result/Result with Regard to Heat Diffusivity]

AS to the graphite-free sheet, the abnormal heat generation zone surface temperature has reached 94° C. after 120 minutes. AS to the graphite lamination type sheets, (b) thin graphite sheet has reached 94° C. after 340 minutes. Next, stable peak temperature under the normal heat generation state, and temperature difference (rise temperature) after 120 minutes elapsing after a start of abnormal heat generation are shown.

TABLE 2
Graphite-free sheet
Symbol A represents a place that is
20 cm away from a heat dissipation zone;
B represents a heat dissipation zone;
and C represents an abnormal heat generation body.

| | (1) At the time of | (2) After 120 | | |
|---|---|---|---|---|
| | a stable peak under | minutes of | Rise | |
| | normal heat | abnormal heat | temperature | |
| | generation | generation | {(2)-(1)} | |
| Thermometer A | 54.6° C. | 53.0° C. | −1.6° | C. |
| Thermometer B | 60.2° C. | 67.8° C. | +7.6° | C. |
| Thermometer C | 54.9° C. | 94.0° C. | +39.1° | C. |

TABLE 3
Graphite lamination type sheet (thin)
Symbol A represents a place that is
20 cm away from a heat dissipation zone;
B represents a heat dissipation zone;
and C represents an abnormal heat generation body.

| | (1) At the time of | (2) After 120 | | |
|---|---|---|---|---|
| | a stable peak under | minutes of | Rise | |
| | normal heat | abnormal heat | temperature | |
| | generation | generation | {(2)-(1)} | |
| Thermometer A | 51.3° C. | 49.6° C. | −1.7° | C. |
| Thermometer B | 53.8° C. | 63.2° C. | +9.4° | C. |
| Thermometer C | 51.4° C. | 84.8° C. | +33.4° | C. |

TABLE 4
Graphite lamination type sheet (thick)
Symbol D represents a place that is
20 cm away from a heat dissipation zone;
E represents a heat dissipation zone;
and F represents an abnormal heat generation body.

| | (1) At the time of | (2) After 120 | | |
|---|---|---|---|---|
| | a stable peak under | minutes of | Rise | |
| | normal heat | abnormal heat | temperature | |
| | generation | generation | {(2)-(1)} | |
| Thermometer D | 51.8° C. | 50.0° C. | −1.8° | C. |
| Thermometer E | 54.0° C. | 64.4° C. | +10.4° | C. |
| Thermometer F | 50.9° C. | 81.4° C. | +30.5° | C. |

TABLE 5
Heat diffusion index comparison

| | Rise | | Rise | Heat |
|---|---|---|---|---|
| | temperature of | | temperature of | diffusion |
| | thermometer B/E | | thermometer C/F | index |
| Graphite-free sheet | +7.6° | C. | +39.1° C. | +31.5° C. |
| Graphite lamination | +9.4° | C. | +33.4° C. | +24.0° C. |
| type sheet/thin | | | | |
| Graphite lamination | +10.4° | C. | +30.5° C. | +20.1° C. |
| type sheet/thick | | | | |

Herein, “heat diffusion index” is one obtained by subtracting heat dissipation zone (B/E) rise temperature from abnormal heat generation zone (C/F) rise temperature, and the higher the heat diffusion effect, the lower the numerical value is.

When comparing this “heat diffusion index” therewith, the graphite lamination type sheet (thin) as well as the graphite lamination type sheet (thick) has lower index value than that of the graphite-free sheet, and thus it has been made clear that the graphite sheet improves heat diffusivity.

Next, time-classified heat diffusion index transition of each of graphite lamination type sheets (thin/thick) will be shown. Herein, in order to further clarify usefulness of the graphite sheet with regard to heat diffusion efficiency, 340 minutes after abnormal heat generation as required time until abnormal heat generation zone sheet surface temperature of the graphite lamination type sheet (thin) reaches 94° C. are used as a reference to compare time-classified heat diffusion index transitions of thin and thick graphite lamination type sheets.

TABLE 6
Heat diffusion index transition

| | After 120 minutes | After 240 minutes | After 340 minutes |
|---|---|---|---|
| | of abnormal heat | of abnormal heat | of abnormal heat |
| | generation | generation | generation |
| Thin sheet | +24.0 | +28.2 | +30.2 |
| Thick sheet | +20.1 | +23.5 | +24.7 |

The graphite-free sheet has a heat diffusion index of +31.5 after 120 minutes of abnormal heat generation, and in contrast, the graphite lamination type sheet has a heat diffusion index of +30.2 (thin) as well as a heat diffusion index of +24.7 (thick) even at the time of lapse of 340 minutes after the abnormal heat generation.

Consequently, it is effective for improving heat diffusivity to laminate the graphite sheet, and according to the graphite lamination type sheet (thin), it is confirmed as the numerical value that required time until reaching the same numerical value (an abnormal heat generation zone sheet surface temperature of 94° C./a heat diffusion index of +30.0 or more) as that of the graphite-free sheet exhibiting inferior heat diffusivity thereto is possible to be elongated 2.8 times or more.

### [Conclusion]

As described above, it is concluded from the verification result according to the present embodiment that it is useful for improving not only heat diffusivity but also suppressing local temperature information by uniformizing a two-dimensional heat distribution to laminate a graphite sheet on the radiation surface of a far-infrared ray radiation sheet.

### [Comparison Made Therebetween in Far-Infrared Radiation Energy Amount Measurement]

Next, as to a conventional type “graphite-free sheet” and a “graphite lamination type sheet” according to the present embodiment, far-infrared radiation energy amounts were measured and both of them were compared.

### [Measurement Date and Time]

Jul. 7, 2017-Jul. 14, 2017

### [Measurement Place]

“Ensekiou technology center at the first IWC factory” inside IWC INC.

### [Measurement Purpose]

It is made clear as the numerical value that how the difference appears in far-infrared radiation energy amount between the conventional type “graphite-free sheet” and the “graphite lamination type sheet” according to the present embodiment.

### [Measurement Outline]

Heating is applied after arranging the conventional type “graphite-free sheet” and the “graphite lamination type sheet” according to the present embodiment under the same condition to measure an infrared radiation energy amount using an infrared ray power meter (TMM-P-10). An infrared ray wavelength band as a measurement object is set to 7-14 μm.

### [Measurement Condition]

Room temperature: 25.0° C.-25.5° C.

Temperature control sensor setting temperature: 50° C. Voltage: 200 V (transformation done by a voltage regulator)

Resistance value: 526Ω (Those having the same resistance value are selected from sheets as respective measurement objects.)

### [Measurement Device]

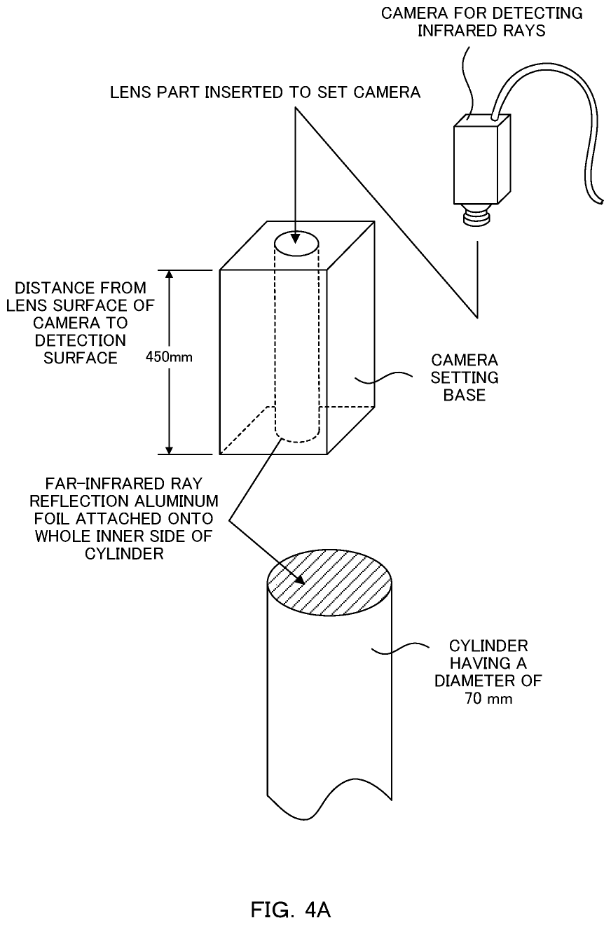

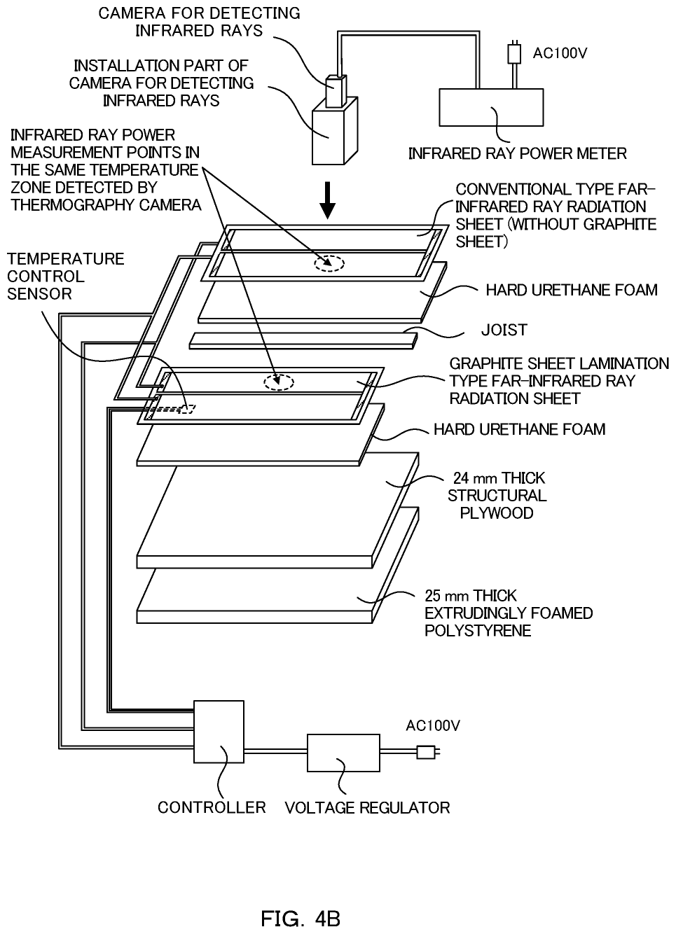

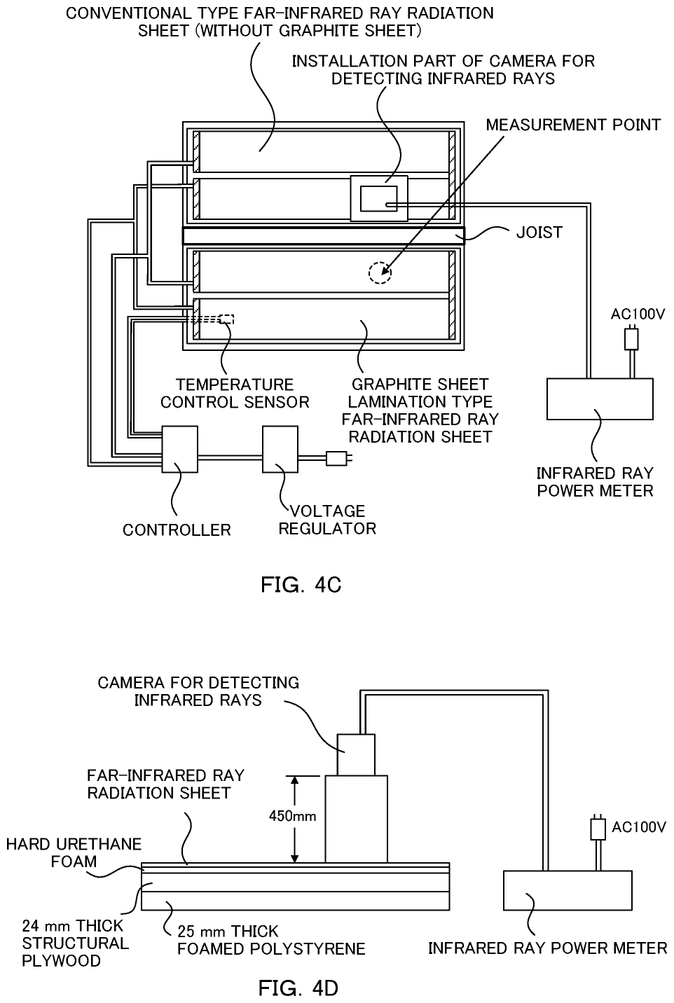

FIG. 4A, FIG. 4B, FIG. 4C and FIG. 4D each are a figure showing a device used for the present measurement in detail. As shown in FIG. 4A, a camera for detecting infrared rays is set on a camera setting base. At this time, a lens part of the infrared ray detection camera is inserted into an opening of the camera setting base to set the camera. When setting the infrared ray detection camera to the camera setting base, a distance from the lens surface of the camera to the detection surface becomes 450 mm. In addition, a far-infrared ray reflection aluminum foil is attached onto the inside of the camera setting base.

### [With Regard to Far-Infrared Ray Power Meter]

As shown in FIGS. B to D, an infrared ray power meter driven at AC100 V is connected to the infrared ray detection camera. This infrared ray power meter (TMM-P-10) dividing radiated infrared energy into three kinds of wavelength bands that are F1 (0.7 to 3 μm), F2 (3 to 7 μm) and F3 (7 to 14 μm) is a photometer capable of measuring a radiant energy amount per unit area (W/cm²). According to this time measurement, manual setting has been made in such a manner that only the wavelength band of F3 (7 to 14 μm) that is also referred to as growth rays in a far-infrared wavelength band out of infrared rays.

### [With Regard to Measurement Point and Temperature Control Sensor]

A slight amount of unevenness is generated in a two-dimensional temperature distribution by location, even though being on the same sheet, as a characteristic of the far-infrared ray radiation sheet according to the present embodiment; and thus as shown in FIG. 4B, both sheets each as a measurement object are measured by a thermography camera before starting measurement, and a place in the same temperature (a circular place having a diameter of 70 mm) is set on each sheet, and determined as a “measurement point” according to the present measurement. Further, for the same reason, in order to eliminate possibly occurring temperature control condition difference during measurement thereof, a temperature control sensor is arranged at one place on a “graphite lamination type sheet” according to the present embodiment.

### [Measurement Procedures]

(Procedure 1) As shown in FIG. 4B, a conventional type “graphite-free sheet” and a “graphite lamination type sheet” according to the present embodiment are arranged concurrently with each other. Then, as shown in FIGS. 4B to 4D, an infrared detection camera of an infrared ray power meter is arranged above a measurement point of each sheet.

(Procedure 2) The infrared ray power meter is set to “FINDER”; matched with the measurement point of the conventional type “graphite-free sheet” or the “graphite lamination type sheet” according to the present embodiment; and manually adjusted so as to make a meter numerical value become zero.

(Procedure 3) Being left standing for about 30 minutes is made after performing zero adjustment of the meter numerical value to confirm stability. When an error takes place during being left standing, the manual adjustment is newly made.

(Procedure 4) A controller provided with a temperature control sensor is turned on to start heating. At the same time, setting of the infrared ray power meter is transferred to “MEASURE” to start measurement thereof.

(Procedure 5) After the controller provided with the temperature control sensor reaches a setting temperature of 50° C., heating becomes the first time OFF, numerical values displayed by the infrared ray power meter are measured for about 60 minutes by being matched with when heating is turned on/off repeated with the controller provided with the temperature control sensor.

### [Measurement Result]

After heating becomes the first time OFF, the average value of each of between 0 and 30 minutes and between 31 and 60 minutes is used with operation of the controller provided with the temperature control sensor, from numerical values of all the measurement results. The unit is all in “×10⁻³ W/cm²”.

TABLE 7
Conventional type “graphite-free sheet”

| | Highest value average | Lowest value average |
|---|---|---|
| | during heating | when turning OFF |
| Between 0 and | 9.078 | 6.237 |
| 30 minutes | | |
| Between 31 and | 9.604 | 6.734 |
| 60 minutes | | |

TABLE 8
“Graphite lamination type sheet”
according to the present embodiment

| | Highest value average | Lowest value average |
|---|---|---|
| | during heating | when turning OFF |
| Between 0 and | 10.983 | 7.348 |
| 30 minutes | | |
| Between 31 and | 11.041 | 7.827 |
| 60 minutes | | |

It is understood from numerical values of these measurement results that the “graphite lamination type sheet” according to the present embodiment has more radiation energy amount in an infrared ray wavelength band of 7 to 14 μm at any time. When finding an increase rate for every time zone, it is described as shown in the following Table.

TABLE 9
Far-infrared radiation energy amount increase rate in
a wavelength band of 7 to 14 μm of the “graphite
lamination type sheet” according to the present
embodiment to the conventional type “graphite-free sheet”

| | Increase rate | Increase rate |
|---|---|---|
| | during heating | when turning OFF |
| Between 0 and | 21% | 18% |
| 30 minutes | | |
| Between 31 and | 15% | 16% |
| 60 minutes | | |

### [Conclusion]

When comparing the “graphite lamination type sheet” according to the present embodiment with the conventional type “graphite-free sheet”, it has become clear that the radiation energy amount in an infrared ray wavelength band of 7 to 14 μm increases by 15% or more.

### [Measurement of Emissivity of Far-Infrared Rays, and Comparison Thereof]

Next, according to each of the conventional type “graphite-free sheet” and the “graphite lamination type sheet” according to the present embodiment, emissivity of far-infrared rays was measured, and both of them were compared with each other. Herein, capability of a graphite sheet to absorb far-infrared rays corresponds to capability to radiate far-infrared rays, and thus it can be said that “high emissivity of far-infrared rays” means that “absorptivity of far-infrared rays is also high”. Herein, “infrared ray radiation emissivity measurements by FTIR” in compliance with “JIS R 1693-2 2012” were carried out for the conventional type “graphite-free sheet” and the “graphite lamination type sheet” according to the present embodiment by requesting a specialized inspection organization (General Incorporated Association Japan Fine Ceramics Center).

### [Using Device]

FTIR device: “System 2000 type produced by Perkin Elmer” was used.

Integrating sphere: This is “RSA-PE-200-ID produced by Labsphere”, and the inside of the sphere is coated by gold.

Integrating sphere incidence diameter: ϕ16 mm Measuring part diameter: ϕ24 mm

### [Measurement Conditions]

Measured area: 370-7800 cm⁻¹ (effective range: 400-6000 cm⁻¹)

The number of integration times: 200 times

Optical source: MIR

Detector: MIR-TGS

Resolution: 16 cm⁻¹

Beam splitter: optimized KBr

In addition, purging was carried out by filling N₂ gas in an optical path from the optical source to the detector.

### [Concrete Measurement]

An aluminum foil is put beneath each sheet, and a reflection spectrum is measured at room temperature to calculate total emissivity at a temperature of each of “25° C., 40° C., 60° C., 80° C. and 100° C.” that are specified from the resulting data.

### [Measurement Result]

The following Table shows the measurement result of total emissivity at each temperature. According to this Table, it is understood that the “graphite lamination type sheet” according to the present embodiment is superior in total emissivity at each temperature to the conventional type “graphite-free sheet”.

TABLE 10

| | Temperature | Total | ±error [%] of |
|---|---|---|---|
| Sample name | [° C.] | emissivity [%] | total emissivity |
| Conventional | 25 | 83.1 | 7.6 |
| type “graphite- | 40 | 84.0 | 6.8 |
| free sheet” | 60 | 85.0 | 6.0 |
| | 80 | 85.8 | 5.2 |
| | 100 | 86.6 | 4.6 |
| “Graphite | 25 | 85.2 | 7.8 |
| lamination type | 40 | 86.0 | 7.0 |
| sheet” according | 60 | 86.9 | 6.1 |
| to the present | 80 | 87.7 | 5.3 |
| embodiment | 100 | 88.4 | 4.7 |

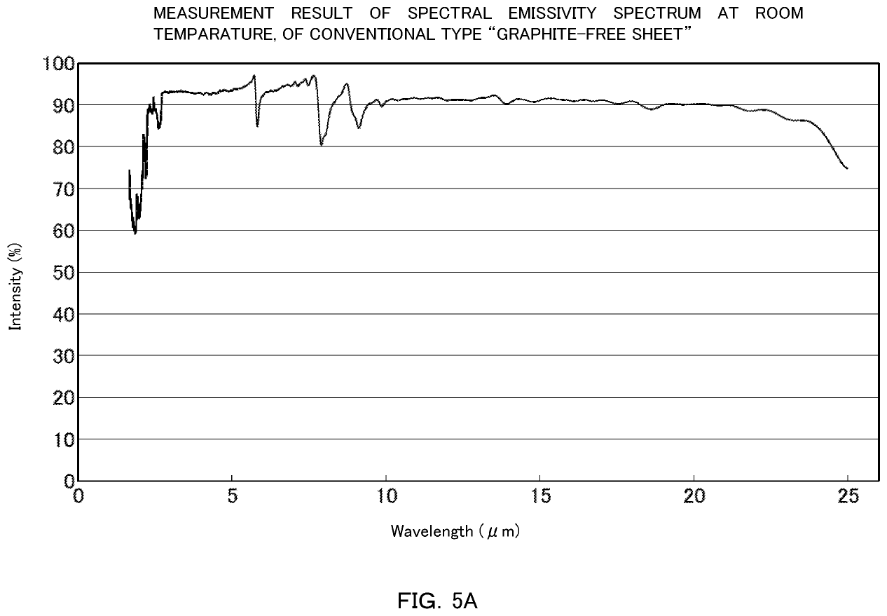

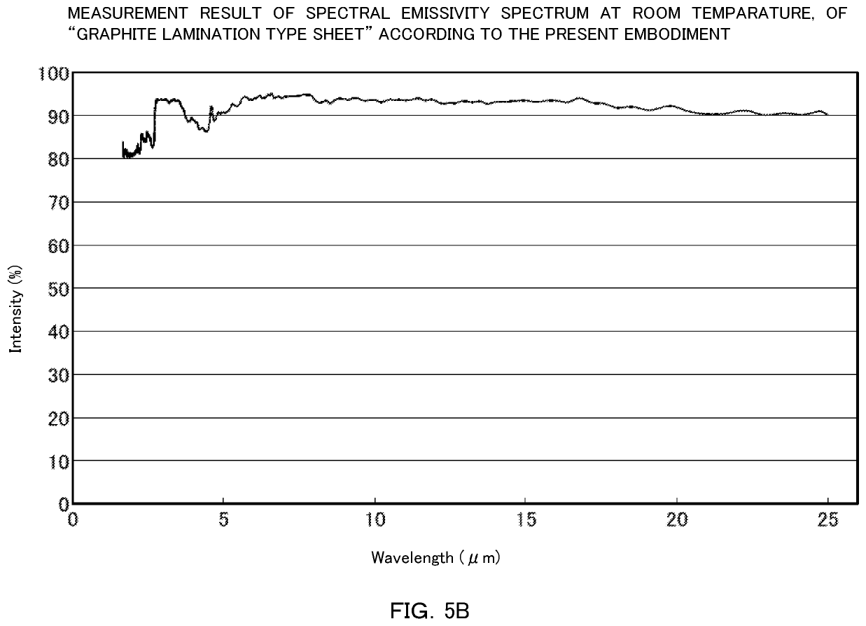

Further, FIG. 5A shows a measurement result of a spectral emissivity spectrum at room temperature for a conventional type “graphite-free sheet”, and FIG. 5B shows a measurement result of a spectral emissivity spectrum at room temperature for a “graphite lamination type sheet” according to the present embodiment. As shown in FIG. 5A, the conventional type “graphite-free sheet” largely rises and falls at an “emissivity (Intensity)” of 80-97%, within a wavelength band of 5-10 μm. Though appearing stable within a wavelength band of 10-20 μm, the “emissivity (Intensity)” remains in the range of 88-93%. In contrast, as shown in FIG. 5B, the “graphite lamination type sheet” according to the present embodiment is stable in a wide wavelength band of 6-25 μm, and exhibits an “emissivity (Intensity)” of 90-95% as a high value. Specifically, at to 14 μm, an “emissivity (Intensity)” of 93-95% is exhibited as a high value, but infrared rays in this wavelength band is called growth rays most effectively acting on a human body, and thus the “graphite lamination type sheet” according to the present embodiment can be said to be also good for a human body. As to the spectral emissivity spectrum measurement, it is rare that a high value is stably exhibited in such a wide wavelength band, and thus it is understood that the “graphite lamination type sheet” according to the present embodiment exhibits a greatly excellent infrared ray radiation characteristic.

### [Flooring Type Floor Heating System]

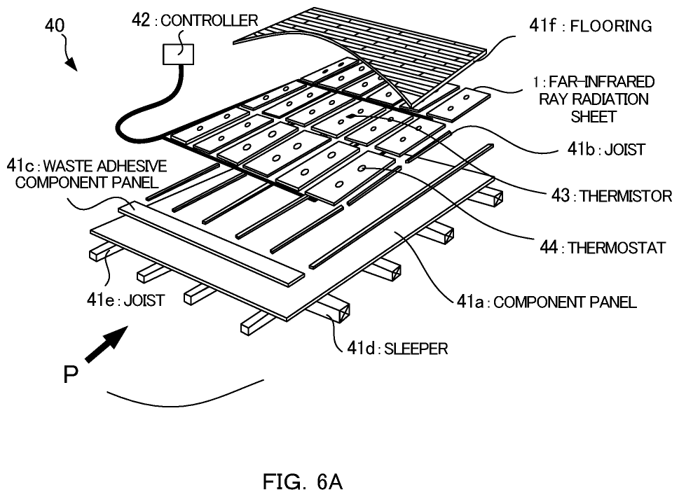

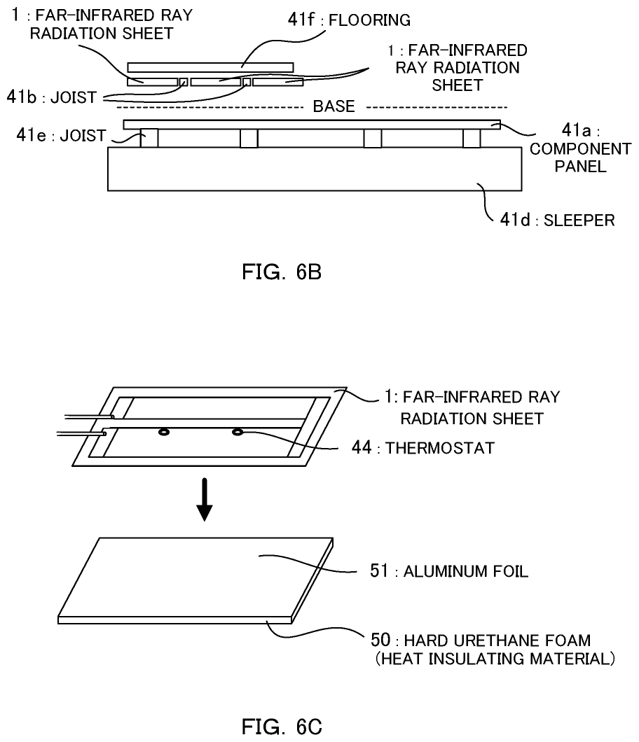

Next, the flooring type floor heating system using a far-infrared ray radiation sheet according to the present invention will be explained. FIGS. 6A and 6B each are a diagram showing a schematic configuration of a flooring type floor heating system according to the present embodiment. FIG. 6A is one viewing a state where the flooring type floor heating system according to the present embodiment is exploded, from an oblique direction; and FIG. 6B is a side view when viewing a partial state where the flooring type floor heating system according to the present embodiment is exploded, from P direction in FIG. 6A. A plurality of far-infrared ray radiation sheets 1 according to the present embodiment are applied in this floor heating system 40. Herein, each far-infrared ray radiation sheet 1 is formed in size being 250 mm long by 900 mm wide. Further, each far-infrared ray radiation sheet 1 is arranged in a matrix shape in a portion surrounded by a joist 41b and a waste adhesive component panel 41c on a component panel 41a. Far-infrared ray radiation sheets each are mutually connected in parallel, and are constituted so as to receive electrical control from a controller 42 as a control section. A component panel 41a is supported by sleepers 41d and joists 41e. As shown in 6B, each far-infrared ray radiation sheet 1 is provided on an upper surface (surface on the far-infrared ray radiation sheet side) of the component panel 41a, via a base; and a flooring 41f is provided on the uppermost surface.

A thermistor 43 as a temperature sensor is provided in any one of far-infrared ray radiation sheets 1 (one centrally positioned in FIG. 6A) among a plurality of the far-infrared ray radiation sheets 1. Temperature information detected by the thermistor 43 is transmitted to the controller 42, and the controller 42 controls current application to each far-infrared ray radiation sheet 1 according to the temperature information. Far-infrared ray radiation sheets 1 each are mutually connected in parallel, and thus it is made possible that temperature controls of all the far-infrared ray radiation sheets 1 are collectively controlled by the controller 42. A batch type temperature control by such thermistor 43 and controller 42 serves as a primary safety device.

Further, a thermostat having an individual switch function is provided in each far-infrared ray radiation sheet 1. FIG. 6C is a schematic diagram of the far-infrared ray radiation sheet 1 provided with a thermostat. For example, the thermostat 44 capable of utilizing a bimetal type detects temperature, and has a function of individually switching current application or non-current application. As shown in FIGS. 6A and 6C, two thermostats 44 are arranged at the position where lateral width of the far-infrared ray radiation sheet whose size is 250 mm long by 900 mm wide is divided into three pieces. Since the thermostats 44 are provided in this manner, when local abnormal heat generation occurs, each thermostat 44 detects this, and switching is made from the current application to the non-current application. Consequently, it becomes possible that current is turned OFF only for the far-infrared ray radiation sheet in which abnormal heat generation temperature is individually detected.

That is, when being laid at a pitch of about 300 mm as floor heating, thermostats 44 are set in an about 300 mm square matrix shape on the entire floor, and thus this serves as a secondary safety device. According to this system, local overheat generation produced at an arbitrary location is to be under the control of the safety device with no gap because of coming into contact with any of the thermostats 44. Further, even when the local overheat generation would be generated in an area smaller than about 300 mm square, the local overheat generation generated at an inner angle of about 300 mm square is sensed by a thermostat 44 at any of corners, and thus actually, there is no gap of the secondary safety device. Consequently, it becomes possible to provide a floor heating system exhibiting high safety.

Further, as shown in FIG. 6C, an aluminum foil 51 is formed on an upper surface of a hard urethane foam 50 of 7-12 mm, as a heat insulating material; and a far-infrared ray radiation sheet 1 in which two thermostats 44 are provided is arranged thereon. In this manner, the hard urethane foam 50 is provided on the lower surface side of far-infrared ray radiation sheet 1, and thus radiation heat of far-infrared rays can be concentrated on the floor surface without leaking under the floor. Further, since the aluminum foil 51 is provided on the surface of the hard urethane foam 50, far-infrared rays are reflected by promoting heat diffusion. According to other heating systems each of a method of using no radiation of far-infrared rays, an aluminum or copper foil is provided on an outermost surface of a heater, but according to the present invention, far-infrared rays are reflected by providing the aluminum foil 51 not on the outermost surface of the radiation surface of the far-infrared ray radiation sheet 1, but only on a lower surface side thereof. As a result of this, far-infrared rays can be concentrated on the floor.

In addition, according to the explanation of the above-described flooring type floor heating system, a “joist construction method” in which for example, a component panel 41a is placed on a joist using a plywood receiving material called the “joist” is shown as an example, but the present invention is not limited thereto. It is also possible that the present invention is applied to a “construction method using no joist (rigid floor construction method)” using not the joist but plywood having a relatively larger thickness than in the joist construction method.

In such a floor heating system 40, according to the far-infrared ray radiation sheet 1, a heat diffusion type mixed paper 10 is laminated on the far-infrared ray radiation surface (vertically upper side) of a heat generation type mixed paper 20, and thus it becomes possible to suppress local temperature rise by promoting heat diffusion at a heat generation place. Further, the heat diffusion type mixed paper 10 diffuses heat and has a function of absorbing and radiating far-infrared rays, and thus utilization without shielding radiation of far-infrared rays and simultaneously, promotion of heat diffusion are made possible; and it becomes possible to improve temperature unevenness, and to be laminated so as to closely adhere to an outermost surface layer portion on the radiation surface of a heat generation type mixed paper 20.

### [First Tatami Mat Type Floor Heating System]

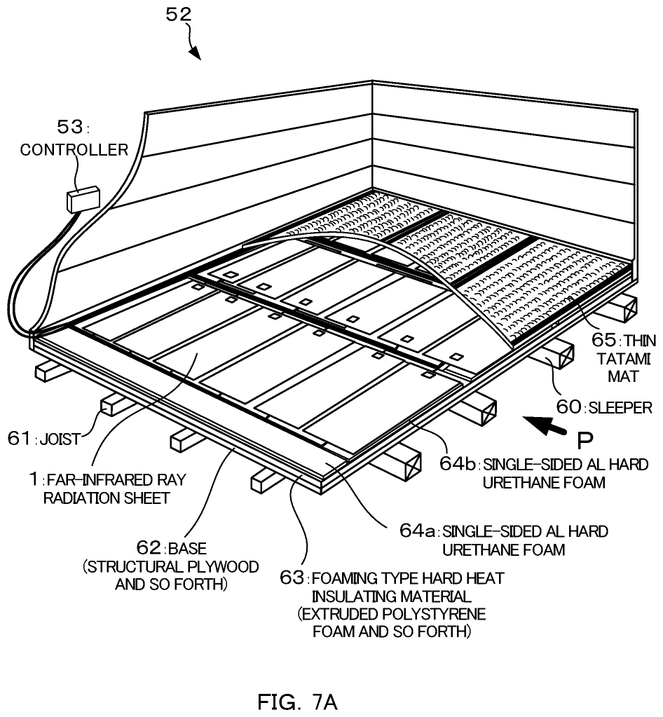

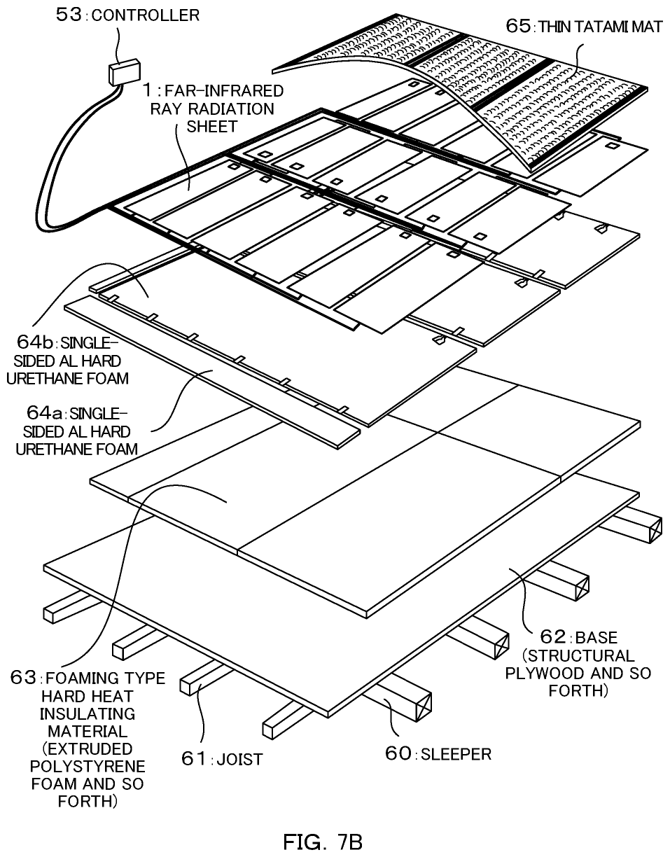

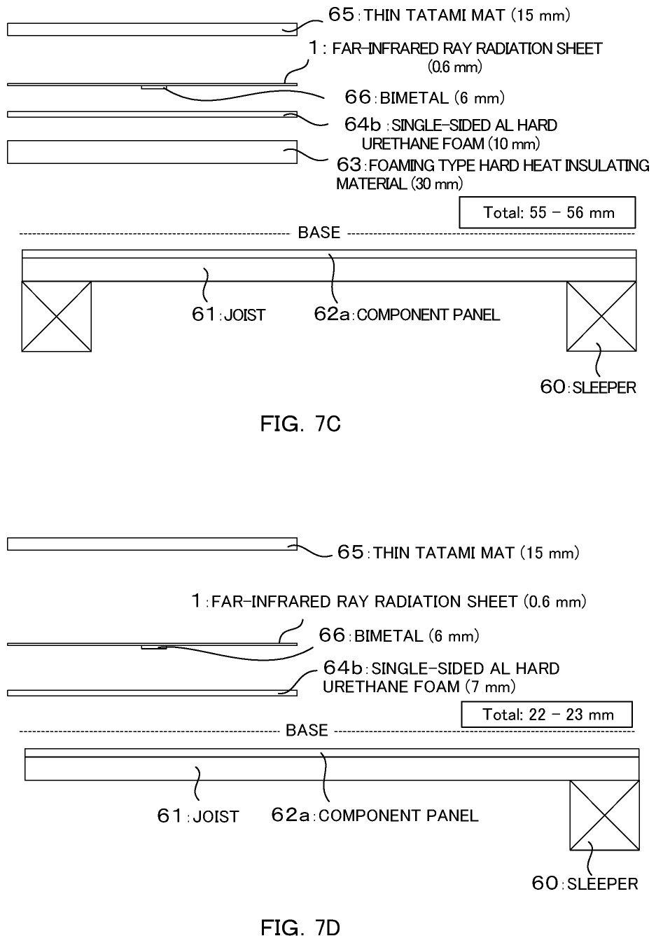

Next, a tatami mat type floor heating system using a far-infrared ray radiation sheet according to the present embodiment will be described. FIG. 7A is a diagram showing an outline of a tatami mat type floor heating system, and FIG. 7B is an exploded configuration diagram of a tatami mat type floor heating system. Herein, one example in which the tatami mat type floor heating system is applied is shown in place of a conventional tatami mat. As shown in FIGS. 7A and 7B, a plurality of far-infrared ray radiation sheets 1 are applied in a tatami mat type floor heating system 52. The size and connection of each far-infrared ray radiation sheet 1 can be constituted similarly to the above-described flooring type floor heating system. Each far-infrared ray radiation sheet 1 is placed on single-sided AL hard urethane foams 64a and 64b in order to insulate heat. Each far-infrared ray radiation sheet 1 that is mutually connected in parallel is constituted so as to receive electrical control from a controller 53 as a control section. Further, a foaming type hard heat insulating material 63 such as an extruded polystyrene foam or the like as an insulating material and for height adjustment is placed beneath the single-sided AL hard urethane foams 64a and 64b (in addition, no limitation thereto as long as a function of heat insulation together with hardness exists). A base 62 formed of veneer or a component panel made from structural plywood or the like is placed beneath the foaming type hard heat insulating material 63, and these are supported by sleepers and joists 61. Then, a thin tatami mat 65 having a thickness of about 15 mm is provided on the uppermost surface as a tatami mat portion.

FIG. 7C is an exploded side view of a tatami mat type floor heating system 52 that is viewed from P direction shown in FIG. 7A. Bimetal 66 as a thermostat is provided on the lower surface side of each of far-infrared ray radiation sheets 1, and individually performs a function of switching current application or non-current application with respect to each of the far-infrared ray radiation sheets 1 while detecting temperature. Further, in this case, a component panel 62a as a base is supported by sleepers 60 and joists 61. As shown in FIG. 7C, the foaming type hard heat insulating material 63 having a thickness of 30 mm, the single-sided AL hard urethane foam 64b having a thickness of 10 mm, the bimetal 66 having a thickness of 6 mm, the far-infrared ray radiation sheet 1 having a thickness of 0.6 mm, and the thin tatami mat having a thickness of 15 mm are laminated, resulting in a total thickness of 55-56 mm when the bimetal 66 has had a local thickness, thereby neglecting the foregoing. According to the JIS standard, a conventional tatami mat has a thickness of 55-60 mm, and thus it is made possible to apply the tatami mat type floor heating system 52 thereto in place of the foregoing.

### [Second Tatami Mat Type Floor Heating System]

FIG. 7D shows a tatami mat type floor heating system of a so-called “construction setting type”, but shows one example in which a tatami mat type floor heating system in place of a conventional flooring is applied. As shown in FIG. 7D, the single-sided AL hard urethane foam 64b having a thickness of 7 mm, the bimetal 66 having a thickness of 6 mm, the far-infrared ray radiation sheet 1 having a thickness of 0.6 mm, and the thin tatami mat having a thickness of 15 mm are laminated on the component panel 62a as a base supported by sleepers 60 and joists 61, resulting in a total thickness of 22-23 mm when the bimetal 66 has had a local thickness, thereby neglecting the foregoing. A conventional flooring has a thickness of 12 mm, and the thickness becomes approximately 7 mm larger when a tatami mat type heating system according to the present embodiment is applied thereto in place of the flooring. According to this configuration, it becomes possible to apply the tatami mat type heating system thereto in place of the foregoing conventional flooring.

In addition, according to the explanation of the above-described first and second tatami mat type floor heating systems, a “joist construction method” in which for example, a component panel 62a is placed on a joist using a plywood receiving material called the “joist” is shown as an example, but the present invention is not limited thereto. It is also possible that the present invention is applied to a “construction method using no joist (rigid floor construction method)” using not the joist but plywood having a relatively larger thickness than in the joist construction method.

### [Dome Type Heating Device]

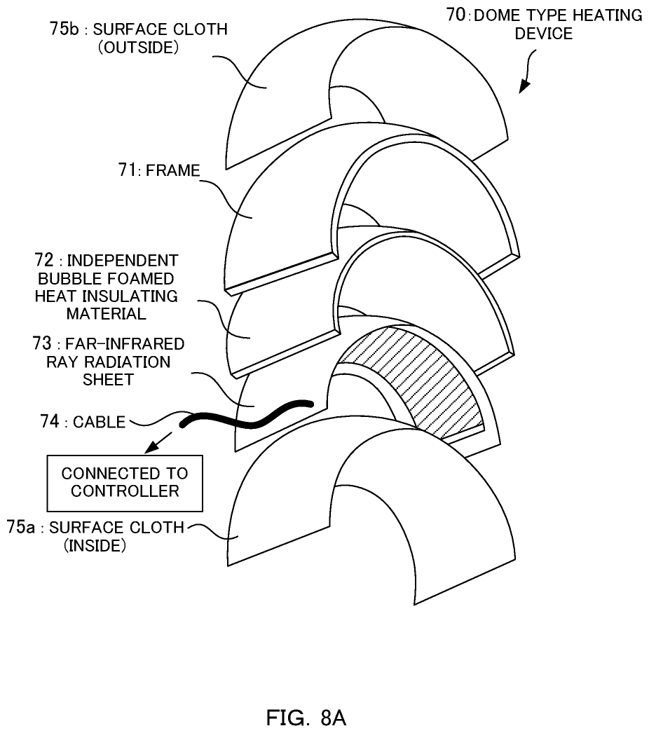

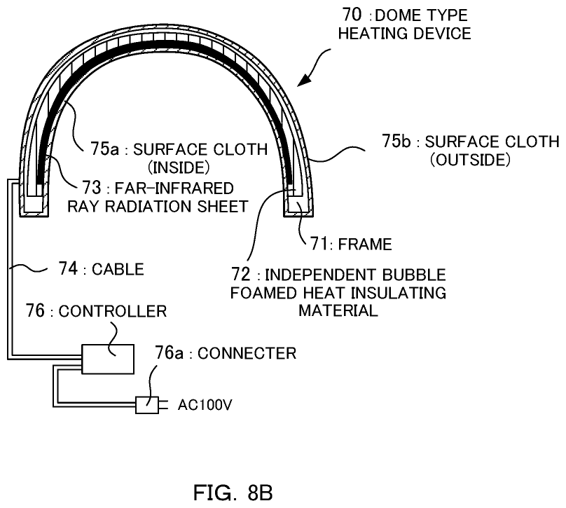

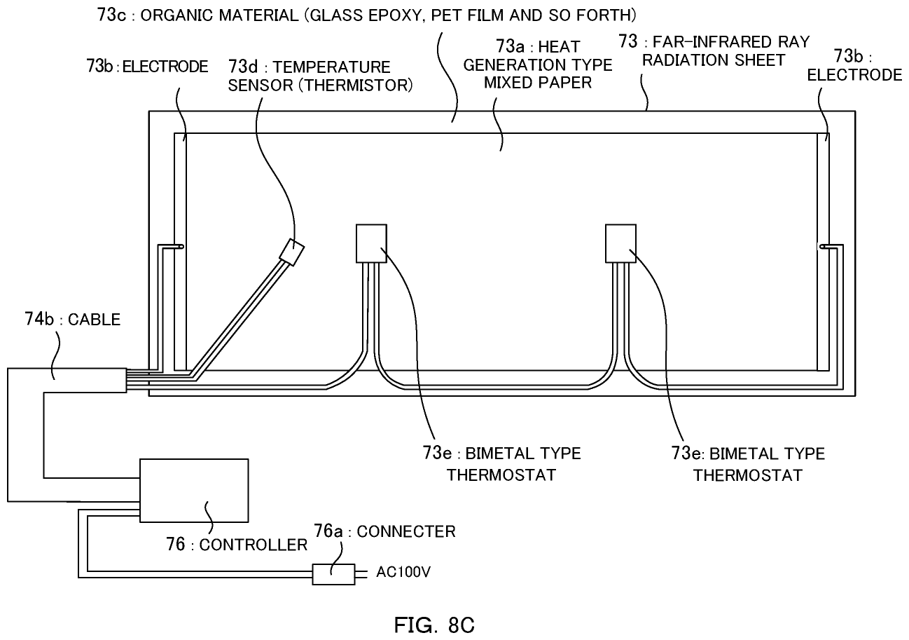

FIG. 8A is an exploded diagram of a dome type heating device according to the present embodiment. According to the dome type heating device 70 formed in a semi-cylindrical shape, the far-infrared ray radiation sheet 73 according to the present embodiment is provided on the inner surface of a frame 71 whose both ends are open. The frame 71 in a hollow semi-cylindrical shape has a cross-sectional shape in an axial direction as a cylinder, that is formed on an arc. That is, a metal frame 71 prepared from aluminum, stainless steel, steel, or the like is coated by surface cloth (outside) 75b as an outer enclosure. This becomes an outer enclosure case. On the other hand, the far-infrared ray radiation sheet 73 attached onto a flexibly independent bubble foamed heat insulating material 72 is coated by surface cloth (inside) 75a. This becomes a far-infrared radiation unit on the radiation side (inner side). The far-infrared radiation unit is fitted onto the inner side of the outer enclosure as described above, and integrated to complete the dome type heating device, and to radiate far-infrared rays from the inner side of the dome. In addition, a cable 74 that is connected to a controller is provided to the far-infrared ray radiation sheet 73.

FIG. 8B is a cross-sectional view in the case of cutting a dome type heating device 70 at the approximate center in an axial direction as a cylinder. As shown in FIG. 8B, the far-infrared ray radiation sheet 73 that is provided on the inner side of the frame 71 is constituted so as to radiate far-infrared rays in the central direction of the arc of the frame 71. The cable 74 is connected to a controller 76, and the controller 76 receives AC 100 V power supply via a connecter 76a.

FIG. 8C that is a plan view of a far-infrared ray radiation sheet 73 used for a dome type heating device 70 corresponds to a plan view of a surface facing to a frame 71 in FIG. 8A out of two surfaces of the far-infrared ray radiation sheet 73. The far-infrared ray radiation sheet 73 having a size of about 330×950 mm and provided with two electrodes 73b at both ends of a heat generation type mixed paper 73a is constituted by packing these with an organic material 73c such as glass epoxy, a PET film or the like. Then, a thermistor as a temperature sensor 73d is arranged at one place and bimetal type thermostats 73e that individually operate a switch function by sensitive temperature are arranged at two places to the far-infrared ray radiation sheet 73. In addition, heat diffusion type mixed paper according to the present embodiment that is not shown in the figure is laminated on heat generation type mixed paper 73a.

The temperature sensor 73d detects surface temperature of the far-infrared ray radiation sheet 73 and transmits temperature information thereof to a controller 76, and the controller 76 performs current application control of the far-infrared ray radiation sheet 73. The bimetal type thermostats 73e performs no operation when control by the temperature sensor 73d works normally, but individually detects temperature and stops power transmission when the temperature sensor 73d causes a failure due to short-circuiting or the like, and there appears some kind of abnormal heat generation to the far-infrared ray radiation sheet 73, thereby functioning as a safety device. According to this configuration, growth rays stably exhibiting high emissivity can be radiated, and thus it becomes possible to realize a heating device that is good for a human body.

As described above, according to the far-infrared ray radiation sheet of the present embodiment, it becomes possible to significantly reduce temperature unevenness inside the sheet, and to further suppress local temperature rise generated when continuing a state where heat dissipation is shielded at an arbitrary location; and it becomes possible to significantly reduce generation of stuffy heat by promoting heat diffusion at an arbitrary heat generation place. Further, it becomes possible to extend time until the stuffy heat is generated. Further, not only high total emissivity of the far-infrared rays in various temperature zones but also highly stable emissivity in a wide wavelength band is obtained, thereby being highly effective as a heater. Further, growth rays stably exhibiting high emissivity can be radiated, and thus it becomes possible to realize a heating device that is good for a human body.

In addition, the present international application claims priority based on Japanese Patent Application No. 2017-003632 for utility model registration, filed on Aug. 7, 2017; and the whole contents of Japanese Patent Application No. 2017-003632 for utility model registration are invoked to the present international application.

### EXPLANATION OF THE SYMBOLS

1 Far-infrared ray radiation sheet
10 Heat diffusion type mixed paper
11 Prepreg
12 Heat diffusion sheet
20 Heat generation type mixed paper
21 Electrode
22 Prepreg
23a, 23b PET film
40 Floor heating system (flooring type)
41a Component panel
41b Joist
41c Waste adhesive component panel
41d Sleeper
41e Joist
41f Flooring
42 Controller
43 Thermistor
44 Thermostat
50 Hard urethane foam
51 Aluminum foil
52 Floor heating system (tatami mat type)
53 Controller
60 Sleeper
61 Joist
62 Base (Structural plywood and so forth)
62a Component panel
63 Foaming type hard heat insulating material
64a, 64b Single-sided AL hard urethane foam
65 Thin tatami mat
66 Bimetal
70 Dome type heating device
71 Frame
72 Independent bubble foamed heat insulating material
73 Far-infrared ray radiation sheet
73a Heat generation type mixed paper
73b Electrode
73c Organic material
73d Temperature sensor
73e Bimetal type thermostat
74 Cable
75a Surface cloth (inside)
75b Surface cloth (outside)
76 Controller
76a Connector

1-4. (canceled)

5. A far-infrared ray radiation sheet formed in a planar shape, that radiates far-infrared rays, the far-infrared ray radiation sheet comprising:
heat generation type mixed paper formed by mixing a basic material and carbon fiber;
electrodes provided to the heat generation type mixed paper;
heat diffusion type mixed paper prepared by compressively paper-making graphite to a basic material containing carbon fiber, that has a function of absorbing and radiating the far-infrared rays; and
organic compound layers laminated on the heat generation type mixed paper and the heat diffusion type mixed paper,
wherein the heat diffusion type mixed paper is laminated on the heat generation type mixed paper,
the heat generation type mixed paper radiates the far-infrared rays by applying current to the electrodes, and
a spectral emissivity spectrum at room temperature stably exhibits an emissivity of 90-95% in a wavelength band of 6-25 μm.

6. The far-infrared ray radiation sheet according to claim 5, wherein
the heat generation type mixed paper and the heat diffusion type mixed paper each are held and packed by a plurality of the organic compound layers to insulate the heat generation type mixed paper and the heat diffusion sheet from each other.

7. A floor heating system using far-infrared rays, the floor heating system comprising:
heat generation type mixed paper formed by mixing a basic material and carbon fiber;
electrodes provided to the heat generation type mixed paper;
heat diffusion type mixed paper prepared by compressively paper-making graphite to a basic material containing carbon fiber, that has a function of absorbing and radiating the far-infrared rays;
organic compound layers laminated on the heat generation type mixed paper and the heat diffusion type mixed paper;
a thermostat that switches current application or non-current application to the heat generation type mixed paper by detecting temperature;
a sensor that detects the temperature; and
a control section that controls the current application to the heat generation type mixed paper in accordance with the temperature detected by the sensor,
wherein the heat diffusion type mixed paper is laminated on the heat generation type mixed paper,
the heat generation type mixed paper radiates the far-infrared rays when the control section applies current to the electrodes, and
a spectral emissivity spectrum at room temperature stably exhibits an emissivity of 90-95% in a wavelength band of 6-25 μm.

8. A dome type heating device that radiates far-infrared rays, the dome type heating device comprising:
a frame, both ends of which are opened, that is formed in a semi-cylindrical shape;
the far-infrared ray radiation sheet according to claim 5, that is provided on an inner surface of the frame; and
cover sections that cover the frame and the far-infrared ray radiation sheet.

9. A dome type heating device that radiates far-infrared rays, the dome type heating device comprising:
a frame, both ends of which are opened, that is formed in a semi-cylindrical shape;
the far-infrared ray radiation sheet according to claim 6, that is provided on an inner surface of the frame; and
cover sections that cover the frame and the far-infrared ray radiation sheet.
